(19) United States
(12) Patent Application Publication
(10) Pub. No.: US 2011/0004728 A1
(43) Pub. Date: Jan. 6, 2011

(54) ON-DEVICE DATA COMPRESSION FOR NON-VOLATILE MEMORY-BASED MASS STORAGE DEVICES

(75) Inventor: Franz Michael Schuette, Colorado Springs, CO (US)

Correspondence Address: HARTMAN & HARTMAN, P.C., 552 EAST 700 NORTH, VALPARAISO, IN, 46383, US

(73) Assignee: OCZ TECHNOLOGY GROUP, INC., San Jose, CA (US)

(21) Appl. No.: 12/496,685

(22) Filed: Jul. 2, 2009

(51) Int. Cl. G06F 12/08; G06F 12/00

(52) U.S. Cl. 711/113; 711/E12.001; 711/E12.019

(57) ABSTRACT

A non-volatile memory-based mass storage device that includes a host interface attached to a package, at least one non-volatile memory device within the package, a memory controller connected to the host interface and adapted to access the non-volatile memory device in a random access fashion through a parallel bus, a volatile memory cache within the package, and co-processor means within the package for performing hardware-based compression of cached data before writing the cached data to the non-volatile memory device in random access fashion and performing hardware-based decompression of data read from the non-volatile memory device in random access fashion.

### BACKGROUND OF THE INVENTION

The present invention generally relates to memory devices for use with computers and other processing apparatuses. More particularly, this invention relates to a non-volatile (permanent) memory-based mass storage device having a memory cache and equipped with an associated co-processor to perform compression and decompression of cached data.

Mass storage devices such as advanced technology attachment (ATA) drives and small computer system interface (SCSI) drives are transitioning away from being electromechanical devices using rotatable media and an actuated read/write head. New technologies enabling non-volatile storage of data have been developed over the past two decades, starting with EPROMs and various iterations of flash memory generally described as solid state media, but also encompassing micro-electromechanical systems (MEMS), nano-technology and molecular-based storage media. At the present, only NAND flash-based drives have gained market acceptance in the form of USB thumb drives or solid state drives (SSD). However, flash technology, regardless of whether it is NAND or NOR, has shortcomings relating to the fact that flash memory is not well suited for use in environments with high requirements of write endurance.

Most shortcomings associated with NAND flash technology originate in the quantum mechanical tunneling through the tunnel oxide to inject electrons in the floating gate for programming purposes and remove electrons for erase cycles. This particular process is very harsh and leaves residues in the form of electrons at broken-bond sites in the bulk and interface of the gates. This ageing of flash as a function of tunnel oxide degradation is typically described as wear, and it is the primary reason why the number of write cycles is finite in flash technology.

Fab process technology has evolved to ever smaller geometries, necessary to enable high density devices on very small footprint. However, with the smaller process technology, interactions between neighboring memory cells increase. As a direct consequence, write endurance is no longer the only factor that needs to be accounted for in the context of wear of flash devices. Rather, interactions between neighboring cells, referred to as read/write disturbance, are becoming increasingly important factors for data retention. In addition, the relatively high read latencies that were tolerable at the time flash memory was first introduced are becoming a performance bottleneck.

In view of the above, it is not surprising that alternative technologies capable of offering better data retention and lower error rates are being considered for mass storage devices. However, a shortcoming of the new technologies of non-volatile memory is that their density still lags behind flash memory. The lower density on the chip level increases cost for high capacity mass storage devices that could eventually replace SSDs or hard disk drives (HDDs). Data compression is a well-accepted method to increase a drive's capacity, particularly for contents in the general area of entertainment or audiovisual content creation. Compression can be done on several levels, including using software and the resources of the system's central processor. However, shortcomings of these compression techniques include their dependence on the host's operating system, giving rise to potential compatibility problems if the device is moved between two systems that are not running the same compression software, or where multiple operating systems are running on the same hardware.

### BRIEF DESCRIPTION OF THE INVENTION

The present invention provides a non-volatile memory-based mass storage device that includes a host interface attached to a package, at least one non-volatile memory device within the package, a memory controller connected to the host interface and adapted to access the non-volatile memory device in a random access fashion through a parallel bus, a volatile memory cache within the package, and co-processor means within the package for performing hardware-based compression of cached data before writing the cached data to the non-volatile memory device in random access fashion and performing hardware-based decompression of data read from the non-volatile memory device in random access fashion.

A notable advantage of using a dedicated co-processor on a mass storage device in accordance with the invention is the ability to operate the device independent of a host's operating system. Moreover, if the device is transferred from one system to another, the compression/decompression functionality as part of the device can be transferred as well, thus eliminating potential compatibility problems as they could arise if both systems were not running the same compression software. Another possible scenario where the device-specific compression approach of this invention may be advantageous is virtualization, where multiple operating systems are running on the same hardware. Other advantages include higher data density and write speeds than what would be possible without compression of data, as well as a lower cost per bit compared to uncompressed data.

Other aspects and advantages of this invention will be better appreciated from the following detailed description.

### BRIEF DESCRIPTION OF THE DRAWINGS

FIG. 1 is a schematic representation of a non-volatile memory-based mass storage device in accordance with the prior art.

FIG. 2 is a diagrammatic representation of the data flow through the mass storage device of FIG. 1.

FIG. 3 is a schematic representation of a non-volatile memory-based mass storage device having a dedicated compression co-processor on the device in accordance with an embodiment of the invention.

FIG. 4 is a diagrammatic representation of the data flow through the non-mass storage device of FIG. 3.

### DETAILED DESCRIPTION OF THE INVENTION

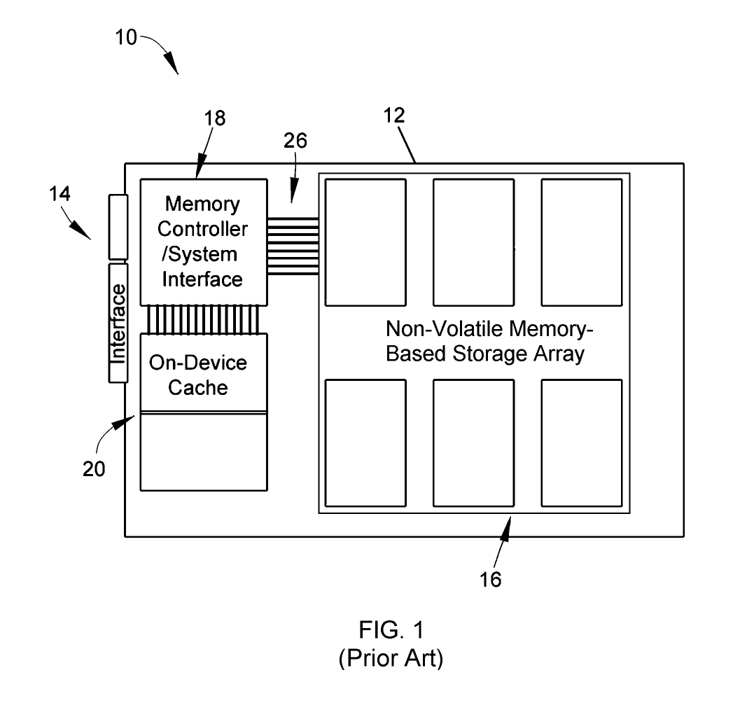

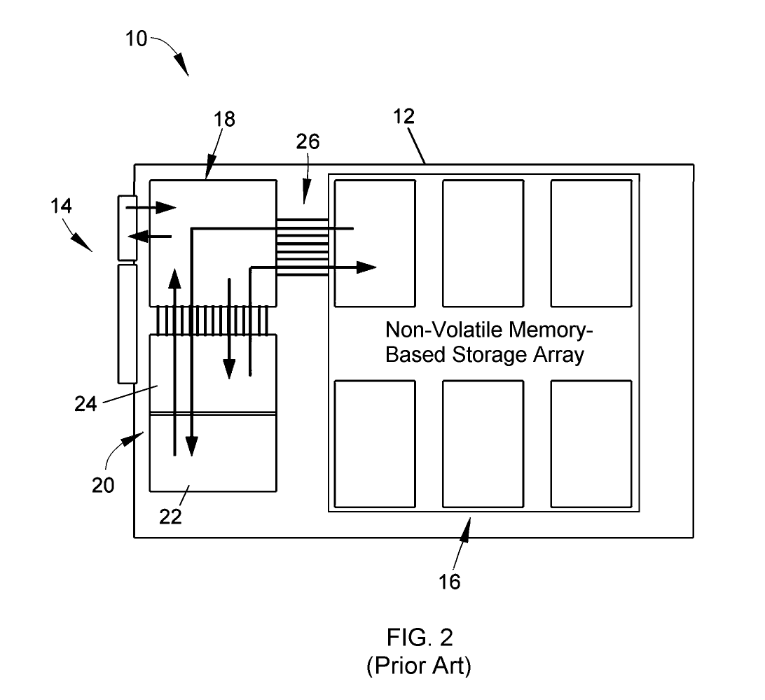

FIGS. 1 and 2 schematically represent a non-volatile memory-based mass storage device 10 of a type known in the art. The device 10 is configured as an internal mass storage device for a computer or other host system (processing apparatus) equipped with a data and control bus for interfacing with the non-volatile mass storage device 10, the bus may operate with any suitable protocol in the art, preferred examples being the advanced technology attachment (ATA) bus in its parallel or serial iterations, fiber channel (FC), small computer system interface (SCSI), and serially attached SCSI (SAS). The type and configuration of the host system to which the mass storage device 10 is connected and used is otherwise not pertinent to an understanding of the invention and, therefore will not be described in further detail.

As understood in the art, the known non-volatile memory-based mass storage device 10 of FIGS. 1 and 2 is adapted to be accessed by a host system (not shown) with which it is interfaced. In FIGS. 1 and 2, this interface is through a Serial ATA (SATA) connector (host) interface 14 carried on a package 12 that defines the profile of the mass storage device 10. Access is initiated by the host system for the purposed of storing (writing) data to and retrieving (reading) data from an array 16 of non-volatile memory devices carried on the package 12, whose construction and configuration will depend on the particular application for the device 10 as well known in the art. The memory device array 16 is made up by at least one type of non-volatile memory that allows data retrieval and storage in random access fashion, using parallel channels 26 to multiple non-volatile input/output pins that can be either on a plurality of devices or else on a parallel bus to a single device.

Because the access operation is initiated by the host system, its implementation will be specific to the particular host system interfaced with the device 10. As schematically represented in FIG. 2, data pass through a memory controller/system interface 18, for example, a system on a chip (SoC) device comprising a host bus interface decoder and a memory controller capable of addressing the non-volatile permanent storage array 16 as well as a volatile memory cache 20 integrated on the device 10. As represented in FIG. 2, read and write operations are carried out through a read and write cache 22 and 24, represented as units of the on-device volatile memory cache 20. The volatile memory cache 20 may be DRAM or SRAM-based, as known and understood in the art.

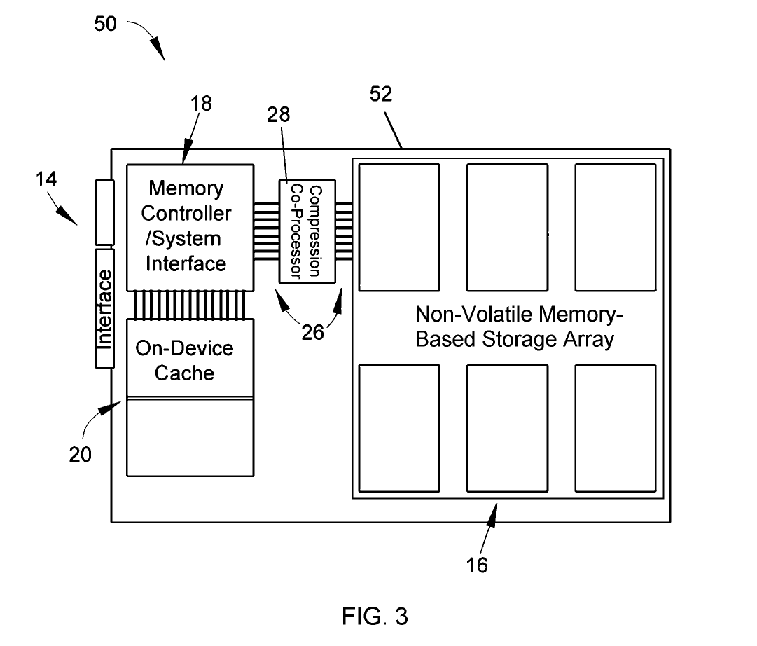

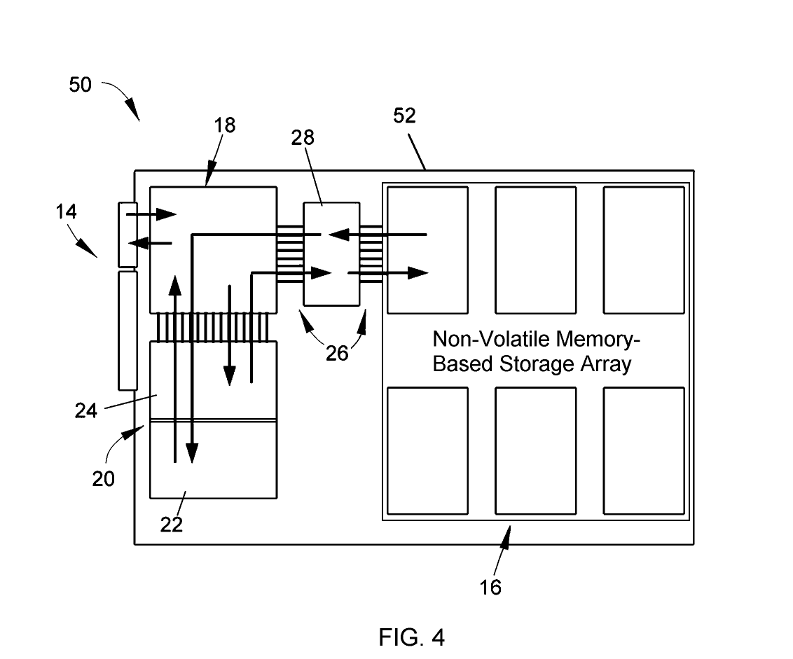

FIGS. 3 and 4 schematically represent a non-volatile memory-based mass storage device 10 in accordance with an embodiment of the invention. As evident from FIGS. 3 and 4, the mass storage device 50 is similar in certain respects to the device 10 of FIGS. 1 and 2, and therefore for convenience FIGS. 3 and 4 use consistent reference numbers to identify components analogous to those of the mass storage device 10 of FIGS. 1 and 2. As with the prior art device 10, the mass storage device 50 comprises a connector (host) interface 14 (e.g., SATA interface), a non-volatile memory-based storage array 16 interfaced with a memory controller/system interface 18 through a parallel access path 26, and read and write cache 22 and 24 represented as units of a volatile memory cache 20, which may be DRAM or SRAM-based as known in the art. Each of these components is physically carried on the package 52 to form a unitary device adapted for interfacing with any suitable host system, and preferably multiple host systems.

In contrast to the device of FIGS. 1 and 2, which does not provide any means for data compression, the mass storage device 50 of FIGS. 3 and 4 is schematically represented as having a dedicated co-processor 28 on the device 10 and within the device package 52. The co-processor 28 provides a device-specific compression and decompression capability on the device 50, and therefore eliminates the need for a compression algorithm provided on a host system to which the device 50 may be connected through the SATA connector interface 14. In this manner, the co-processor 26 can be employed to perform “on-the-fly” compression of cached data in the write cache 24 before writing the cached data to the non-volatile memory-based storage array 16, and thereafter decompression of the data read from the non-volatile memory-based storage array 16 before relaying the read data to the read cache 22. As such, the device 10 is a peripheral device that carries its own embedded compression-decompression co-processor 26 that increases the throughput and memory capacity of the non-volatile memory-based storage array 16. Furthermore, the mass storage device 50 is preferably capable of exhibiting a higher write speed capability than what would be possible with the device 10 of FIGS. 1 and 2, and may also be capable of higher read speed than what would be possible with the device 10 of FIGS. 1 and 2.

Devices suitable for the co-processor 26 are within the scope of those skilled in the art, and it is foreseeable that existing devices could be adapted to perform the compression-decompression operation of this invention. Furthermore, the co-processor 26 may operate on any type of operating system known or developed in the future. Implementation of the compression and decompression algorithms can be with any suitable standard currently existing, including but not limited to PKZIP, RAR and LWZ, or any other algorithm developed in the future. In one embodiment, the co-processor 26 has a prefetch scheduler capability to better optimize scheduling of read operations based on probability of the next access. For this purpose, the co-processor 26 may read the data out directly into the read cache 22 or have a buffer for prefetched data.

While certain components are shown and preferred for the non-volatile memory-based mass storage device 50 of this invention, it is foreseeable that functionally-equivalent components could be used or subsequently developed to perform the intended functions of the disclosed components. For example, emerging memory technologies such as those based on a phase change memory, ferromagnetic memory, organic memory, resistive random access memory, and nanotechnology substrates could in the future become the storage media of choice. Therefore, while the invention has been described in terms of a preferred embodiment, it is apparent that other forms could be adopted by one skilled in the art, and the scope of the invention is to be limited only by the following claims.

1. A non-volatile memory-based mass storage device comprising:
a package;
a host interface attached to the package;
at least one non-volatile memory device within the package;
a memory controller connected to the host interface and adapted to access the non-volatile memory device in a random access fashion through a parallel bus;
volatile memory cache within the package; and
co-processor means within the package for performing hardware-based compression of cached data before writing the cached data to the non-volatile memory device and performing hardware-based decompression of data read from the non-volatile memory device.

2. The mass storage device according to claim 1, wherein the non-volatile memory device comprises a phase change memory device, a ferromagnetic memory device, an organic memory device, a resistive random access memory device, or a nanotechnology substrate.

3. The mass storage device according to claim 1, wherein the mass storage device has a higher write speed capability than would be possible if the mass storage device did not comprise the co-processor means.

4. The mass storage device according to claim 1, wherein the mass storage device has a higher read speed capability than would be possible if the mass storage device did not comprise the co-processor means.

5. The mass storage device according to claim 1, wherein the host interface comprises a SATA or SAS interface device.

6. The mass storage device according to claim 1, wherein the volatile memory cache is DRAM-based cache.

7. The mass storage device according to claim 1, wherein the volatile memory cache is SRAM-based cache.

8. The mass storage device according to claim 1, wherein the cache comprises write cache.

9. The mass storage device according to claim 1, wherein the cache comprises read cache.

10. The mass storage device according to claim 1, wherein the co-processor means comprises prefetch scheduler means.

11. The mass storage device according to claim 1, wherein the hardware-based compression and decompression performed by the co-processor means utilizes a compression-decompression algorithm chosen from the group consisting of PKZIP, RAR and LWZ.

12. A non-volatile memory-based mass storage device comprising:
a package;
an ATA interface device on the package for interconnecting the mass storage device to an ATA port;
at least one non-volatile memory device within the package;
a memory controller connected to the interface device and adapted to access the non-volatile memory device in a random access fashion through a parallel bus;
DRAM-based or SRAM-based cache within the package; and
co-processor means within the package for performing hardware-based compression of cached data before writing the cached data to the non-volatile memory device in random access fashion and performing hardware-based decompression of data read from the non-volatile memory device in random access fashion.

13. The mass storage device according to claim 12, wherein the mass storage device has a higher write speed capability than would be possible if the mass storage device did not comprise the co-processor means.

14. The mass storage device according to claim 12, wherein the mass storage device has a higher read speed capability than would be possible if the mass storage device did not comprise the co-processor means.

15. The mass storage device according to claim 12, wherein the cache is DRAM-based.

16. The mass storage device according to claim 12, wherein the cache is SRAM-based.

17. The mass storage device according to claim 12, wherein the cache comprises write cache.

18. The mass storage device according to claim 12, wherein the cache comprises read cache.

19. The mass storage device according to claim 12, wherein the co-processor means comprises prefetch scheduler means.

20. The mass storage device according to claim 12, wherein the hardware-based compression and decompression performed by the co-processor means utilizes a compression-decompression algorithm chosen from the group consisting of PKZIP, RAR and LWZ.
